(19) United States
(12) Patent Application Publication
(10) Pub. No.: US 2017/0104848 A1
(43) Pub. Date: Apr. 13, 2017

(54) MULTI-REQUEST AGGREGATION

(71) Applicant: Giraffic Technologies Ltd., Tel Aviv (IL)

(72) Inventors: Yoel Zanger, Tel Aviv (IL); Rotem Epelbaum, Ramat Gan (IL); Ofer Atziz, Tel Aviv (IL)

(21) Appl. No.: 15/272,520

(22) Filed: Sep. 22, 2016

(30) Foreign Application Priority Data
Oct. 7, 2015 (IL) 241947

(51) Int. Cl. H04L 29/08; H04L 29/06

(52) U.S. Cl. CPC H04L 67/327; H04L 67/02; H04L 65/601; H04L 67/42

(57) ABSTRACT

A method of accelerating content download receives, by an acceleration module from a requester, at least one first request for at least part of a requested content download. The acceleration module sends to a server storing the requested content a plurality of second requests covering the at least part of the requested content. The acceleration module receives from the server and sends to the requester, content for fulfilling at least one of the at least one first request.

### FIELD

The present invention generally relates to download speed improvement and specifically to acceleration of content download.

### BACKGROUND

A fundamental issue in HTTP streaming concerns the granularity of objects used throughout the HTTP ecosystem (including clients, proxy caches, CDN nodes, and servers). A file may be downloaded with a single connection that streams the entire file, or with several connections, by using offset ranges called chunks, each containing a part of data from the file.

In Adaptive streaming, in order to allow switching between qualities, the player downloads fragments or chunks of the content. At the end of each fragment the player may select to download a different quality.

In Progressive Streaming a single file, e.g. video file, is downloaded from an HTTP web server, which may start playing before the data transfer is completed. In order to play the video smoothly, the data rate of the encoded file must be smaller than the throughput of the remote viewer; otherwise, the video will frequently stop playing.

A common problem we have encountered when attempting to accelerate a progressive or adaptive streaming is that different clients, for example, different players, have different algorithms of streaming content.

Requests for content, sent by the player, may come in different chunks, sometimes unordered or with overlaps.

Moreover, prior art systems treat each request as a stand-alone request and are therefore limited in providing download optimization to the requested data chunk without taking into consideration other requests.

### SUMMARY

According to an aspect of the present invention there is provided a system for accelerating content download comprising: a requester configured to request content download; a server configured to store content; and an acceleration module connected with said requester and said server and configured to receive from said requester at least one first request for at least part of said content, send to said server a plurality of second requests covering said at least part of said content and receive from said server and send to said requester content for fulfilling at least one of said at least one first request.

The content may comprise one of a video file and a text file.

The requester may be comprised in a device.

The device may comprise one of a computer, a set-top box, a tablet, a smartphone, a smart TV and a game console.

The acceleration module may comprise a buffer configured to store said content for fulfilling at least one of said at least one first request.

The acceleration module may further be configured to receive from said requester at least one third request for at least another part of said content.

The acceleration module may be configured to decide whether to use a new buffer configured to store said content for fulfilling said third request.

According to another aspect of the present invention there is provided a method of accelerating content download comprising: receiving by an acceleration module, from a requester, at least one first request for at least part of a requested content download; sending by said acceleration module to a server storing said requested content a plurality of second requests covering said at least part of said requested content; and receiving by said acceleration module, from said server, and sending by said acceleration module to said requester, content for fulfilling at least one of said at least one first request.

The content may comprise one of a video file and a text file.

The requester may be comprised in a device.

The device may comprise one of a computer, a set-top box, a tablet, a smartphone, a smart TV and a game console.

The acceleration module may comprise a buffer configured to store said content for fulfilling at least one of said at least one first request.

The method may further comprise the steps of: receiving by an acceleration module, from said requester, at least one third request for at least another part of said requested content; sending by said acceleration module to said server storing said requested content said third request covering said at least other part of said requested content; and receiving by said acceleration module, from said server, and sending by said acceleration module to said requester, content for fulfilling said at least one third request.

The method may further comprise the step of deciding whether to use a new buffer in order to store said content for fulfilling said at least one third request.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic representation of the system for carrying out the present invention;

FIG. 2A is a schematic exemplary process performed by the system according to embodiments of the present invention;

FIGS. 2B and 2C are a flowchart showing the same exemplary process shown in FIG. 2A; and

FIG. 3 demonstrates four exemplary different scenarios for requests requested by the requester.

### DETAILED DESCRIPTION

In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are non-limiting. It is contemplated that there are other methods and systems that are within the scope of the present embodiment. Also, the same reference numerals are used in the drawings and in the description to refer to the same elements to simplify the description.

The present embodiment overcomes the deficiencies of prior art download acceleration methods by recognizing a plurality of requests as referring to the same content and using this fact to optimize the content's download.

Mentions of the term “range request” in the present application include both explicit and implicit range request implementations, such as, for example:

A single HTTP request from the beginning till the end of the content.

Multiple HTTP range requests to download chunks, each consisting of a part of the content and with its own URL.

Different HTTP requests that download parts of the content. (For example, when the range is given as a parameter of the URL).

Requests for fragments of the content (Like in Adaptive Streaming).

The present embodiment provides for:

Acceleration of requests for content containing range request.

Acceleration of parallel requests (a new request arrives from a requester before returning the data for the previous request).

Acceleration of different requests for the same content (source file).

The methodology identifies requests for the same content, combines these requests into the same session, unifies these requests in a novel methodology and accelerates them together.

It will be appreciated that the content may be any type of file, such as for example, a video file, a text file, etc. or a set of files (like in adaptive streaming) which may be allowed, by a server storing it, to be downloaded in parts.

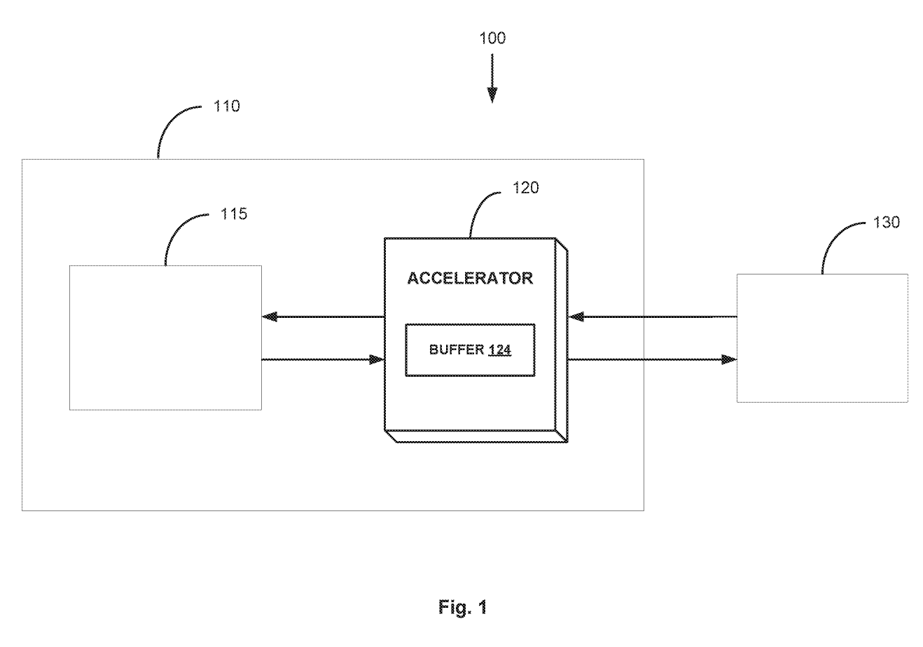

FIG. 1 is a schematic representation of a system 100 for carrying out the present embodiment, comprising a device 110 comprising a requester 115 (e.g. a native player) and an accelerator module or circuit 120 of the present embodiment configured to perform multi-request aggregation according to the present embodiment. The system 100 also comprises a server or data source 130 which receives the aggregated requests from the accelerator module 120 and provides accelerated data to the accelerator module 120, to be communicated back to the requester 115 in accordance with the original requests.

The device 110 may be a computer, set-top box, tablet, smartphone, smart TV, game console or any other device that can connect to the internet and which has a processor circuit and memory circuit.

The accelerator module 120 uses at least a buffer 124 and may be installed in the device 110 or in any device that transfers the requests and the data between the device 110 and the server 130, such as for example, a router.

The accelerator module 120 assumes that a requester which requests a part of the content needs at least a few more parts if not the whole content and not just the requested part. Therefore, towards the server, a request for a download that arrives from the requester which requests a part of the content is considered as having requested the content up to the accelerator's buffer limitations.

Other requests for the same content may join the first request.

Downloads of the accelerator's requested data from the server are accelerated, with multiple requests, and the accelerator fills its buffer till it reaches its maximum size. In the meantime, the requester receives only the data it requested.

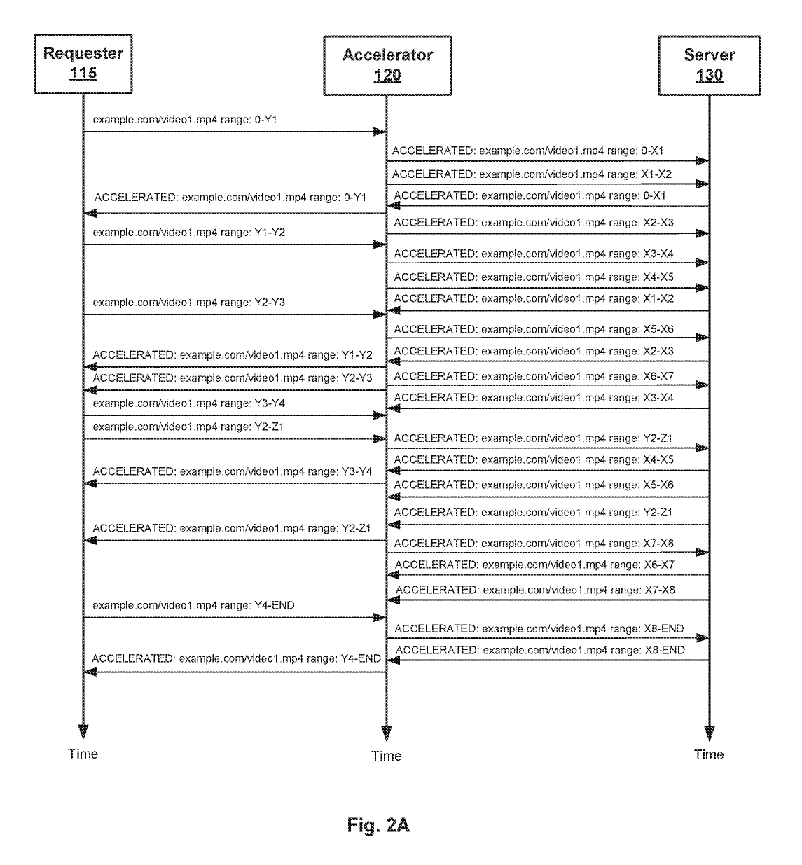

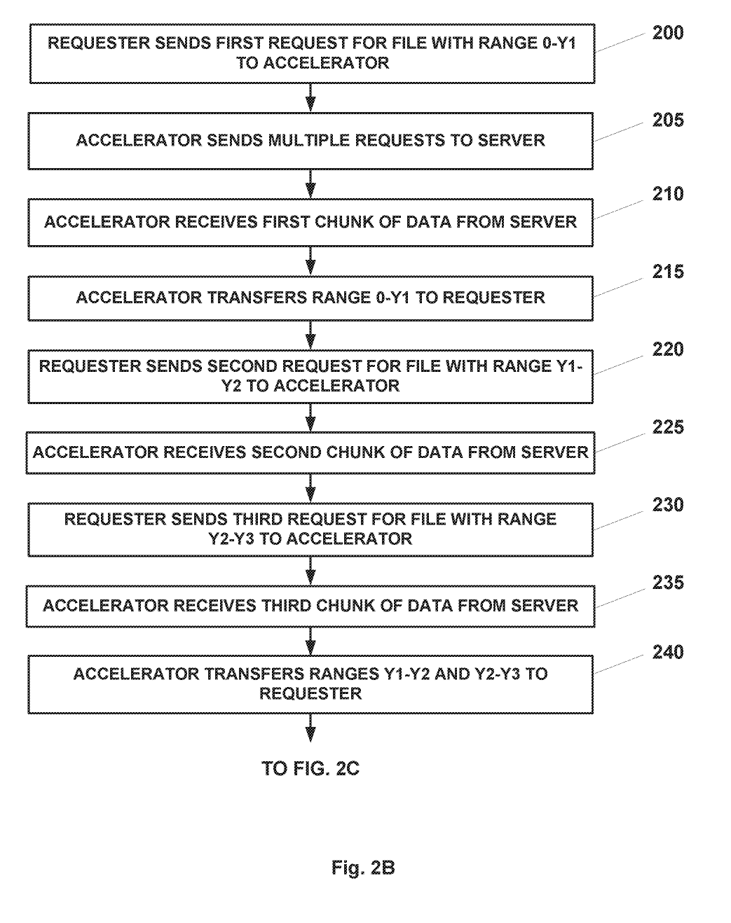

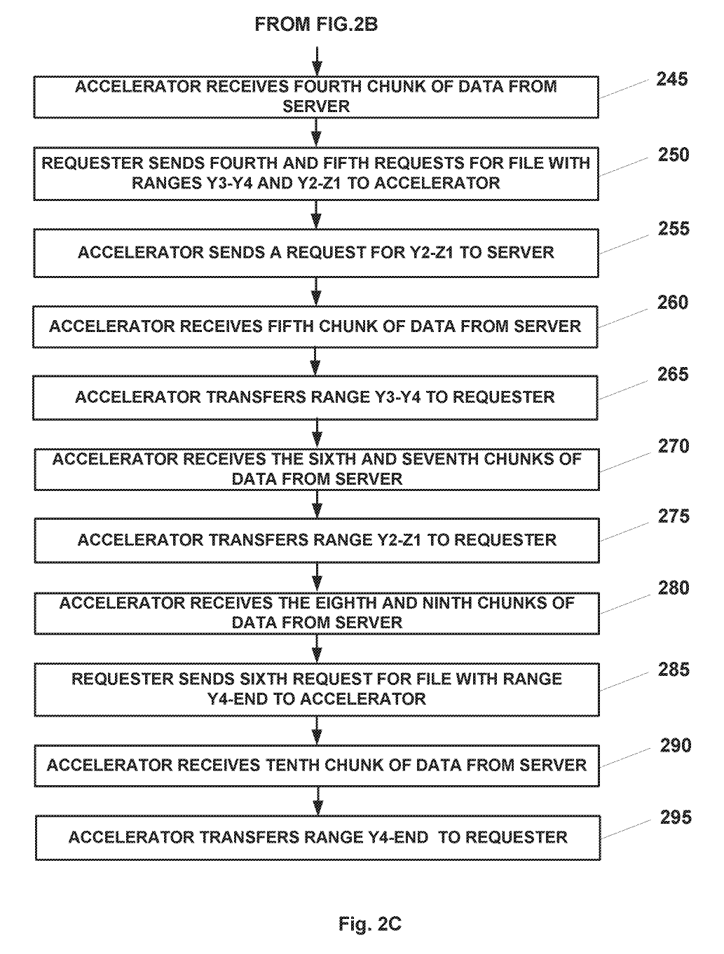

FIG. 2A is a schematic exemplary process performed by the system according to embodiments of the present invention.

FIGS. 2B and 2C are a flowchart showing the same exemplary process shown in FIG. 2A.

In step 200, the requester sends a first request for a file (e.g. a video file-example.com/video.mp4) with a specified range of bytes 0-Y1.

In step 205, the accelerator intercepts the request and transforms it into multiple requests potentially covering the entire requested file (up to the accelerator's buffer limitations and according to the actual requester request). The multiple requests are forwarded to the server. In step 210, the accelerator receives the first data chunk (range of bytes 0-X1) from the server. According to this exemplary process, range 0-X1 comprises at least the range 0-Y1 requested by the requester. In step 215 the accelerator transfers range 0-Y1 to the requester. In step 220, the requester sends a second request for the same file with a specified range of bytes Y1-Y2. In step 225, the accelerator receives the second data chunk (X1-X2) from the server. In step 230, the requester sends third request for the same file with a specified range of bytes Y2-Y3. In step 235, the accelerator receives the third data chunk (X2-X3) from the server. According to this exemplary process, the ranges Y1-Y2 and Y2-Y3 requested by the requester are included in the range 0-X3. In step 240 the accelerator transfers ranges Y1-Y2 and Y2-Y3 to the requester. In step 245 (FIG. 2C), the accelerator receives the fourth data chunk (X3-X4) from the server. In step 250, the requester sends fourth and fifth requests for the same file with a specified range of bytes Y3-Y4 and Y2-Z1. The request for range Y2-Z1 is unpredicted and may be caused for example, in case of a video file, by the user who rewinds the video, or due to the requester's own logic unfamiliar to the accelerator. Therefore, in step 255, the accelerator has to send a special request for range Y2-Z1 to the server. This request may stand alone and might not be attached to the other requests. In step 260, the accelerator receives the fifth data chunk (X4-X5) from the server. According to this exemplary process, the range Y3-Y4 requested by the requester is included in the range 0-X5. In step 265, the accelerator transfers range Y3-Y4 to the requester. In step 270, the accelerator receives the sixth (X5-X6) and the seventh (Y2-Z1) data chunks from the server. According to this exemplary process, the range Y2-Z1 requested by the requester is included in the accelerator's requests Y2-Z1. In step 275, the accelerator transfers range Y2-Z1 to the requester. In step 280, the accelerator receives the eighth (X6-X7) and ninth (X8-X9) data chunks from the server. In step 285, the requester sends sixth request for the same file with a specified range of bytes Y4-END. In step 290, the accelerator receives the tenth data chunk (X8-END) from the server. According to this exemplary process, the range Y4-END requested by the requester is included in the data received by at least one of the accelerator's requests. In step 295, the accelerator transfers range Y4-END to the requester.

As can be seen in the exemplary request for range Y2-Z1, during the acceleration, the accelerator has to decide whether to open a new buffer according to the requester's demand for range, or if it can use the data that has already been downloaded and return it to the requester without the need to open a new buffer.

In order to make this decision, the accelerator checks the start offset of the requested range against the buffer state, namely the Buffer start position—the pointer to the beginning of available downloaded data, or basically—the beginning of the buffer, the Write position—the next position to which the accelerator should write the data arriving from the server and the OFFSET—additional offset from the end of the buffer in which a new request will be accepted to the current buffer.

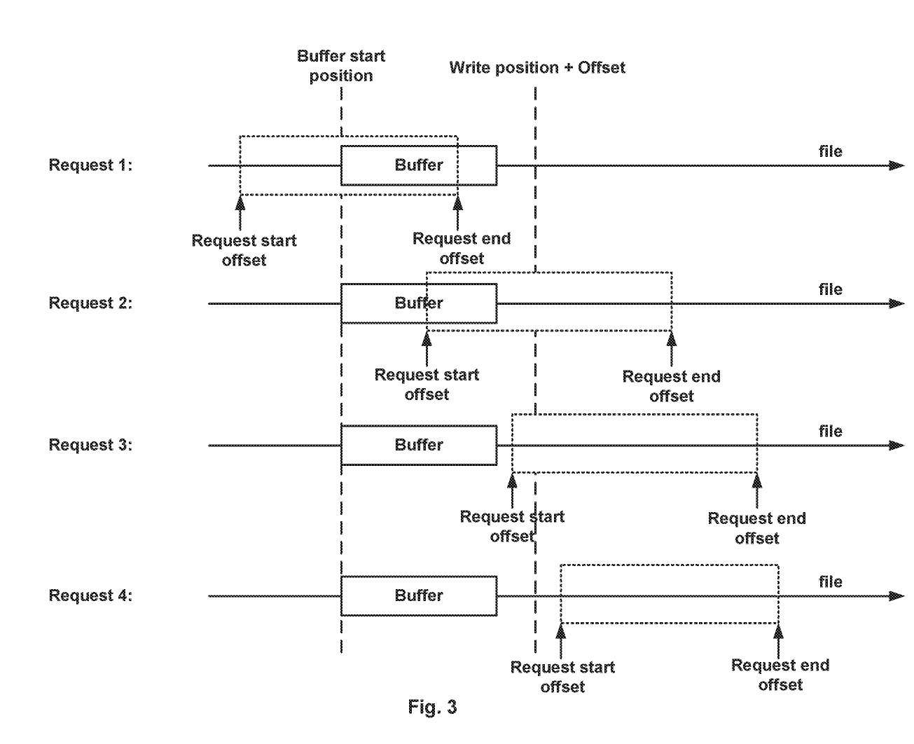

FIG. 3 demonstrates four exemplary different scenarios for requests requested by the requester.

For each of the following different positions there is a different behavior:

Exemplary request number 1: When the start offset of the request is BEFORE the Buffer Start position: a new buffer for this request has to be opened since this data was already sent to the requester and deleted from the buffer.

Exemplary request number 2: When the start offset is equal to or after the Buffer Start position but before the Write position+Offset (e.g. 5 MB): In this scenario no new buffer for this request has to be opened, the request is added to the previous requests that the requester initiated.

Exemplary request number 3: When the start offset is after the end of the buffer but before or equal to the Write position+Offset (e.g. 5 MB): In this scenario no new buffer for this request has to be opened, the request is added to the previous requests that the requester initiated.

Exemplary request number 4: When the start offset is after the Write position+Offset. In this scenario the buffer does not have the requested data therefore a new buffer for this requested data has to be opened.

In other words, the accelerator's behavior is as follows:

If (Buffer Start≦Request Start offset Write+Offset)→the request is added to the previous request that the requester initiated.

Else, the accelerator opens a new buffer for this request.

It will be appreciated that that the requests may be HTTP requests, HTTPS requests or any other request which may comprise a range.

The operations and algorithms described herein can be implemented as executable code within a processor circuit of the device 110, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit can be implemented, for example, using a non-volatile memory such as a programmable read only memory (PROM) or an EPROM, and/or a volatile memory such as a DRAM, etc.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A system for accelerating content download comprising:
a requester configured to request content download;
a server configured to store content; and
an acceleration module connected with said requester and said server and configured to receive from said requester at least one first request for at least part of said content, send to said server a plurality of second requests covering said at least part of said content and receive from said server and send to said requester content for fulfilling at least one of said at least one first request.

2. The system of claim 1, wherein said content comprises one of a video file and a text file.

3. The system of claim 1, wherein said requester is comprised in a device.

4. The system of claim 3, wherein said device comprises one of a computer, a set-top box, a tablet, a smartphone, a smart TV and a game console.

5. The system of claim 1, wherein said acceleration module comprises a buffer configured to store said content for fulfilling at least one of said at least one first request.

6. The system of claim 1, wherein said acceleration module is further configured to receive from said requester at least one third request for at least another part of said content.

7. The system of claim 6, wherein said acceleration module is configured to decide whether to use a new buffer configured to store said content for fulfilling said third request.

8. A method of accelerating content download comprising:
receiving by an acceleration module, from a requester, at least one first request for at least part of a requested content download;
sending by said acceleration module to a server storing said requested content a plurality of second requests covering said at least part of said requested content; and
receiving by said acceleration module, from said server, and sending by said acceleration module to said requester, content for fulfilling at least one of said at least one first request.

9. The method of claim 8, wherein said content comprises one of a video file and a text file.

10. The method of claim 8, wherein said requester is comprised in a device.

11. The method of claim 10, wherein said device comprises one of a computer, a set-top box, a tablet, a smartphone, a smart TV and a game console.

12. The method of claim 8, wherein said acceleration module comprises a first buffer configured to store said content for fulfilling at least one of said at least one first request.

13. The method of claim 12, further comprising the steps of:
receiving by an acceleration module, from said requester, at least one third request for at least another part of said requested content;
sending by said acceleration module to said server storing said requested content said third request covering said at least other part of said requested content; and
receiving by said acceleration module, from said server, and sending by said acceleration module to said requester, content for fulfilling said at least one third request.

14. The method of claim 13, further comprising the step of:
deciding whether to use a second buffer in order to store said content for fulfilling said at least one third request.
